(19) United States
(12) Patent Application Publication
(10) Pub. No.: US 2004/0093191 A1
(43) Pub. Date: May 13, 2004

(54) System and method for performing modal analysis of at least one remote structure

(75) Inventors: Jan Jeppsson, Sumner, WA (US); Liangji Xu, Kent, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company, Chicago, IL

(21) Appl. No.: 10/292,041

(22) Filed: Nov. 12, 2002

(51) Int. Cl. G06F 17/50

(52) U.S. Cl. 703/1

(57) ABSTRACT

A system and method are provided for performing a modal analysis of at least one structure across a wide area network (WAN). The system includes at least one data acquisition assembly and at least one central processing element. The data acquisition assemblies are capable of acquiring data from the structure, where the data comprises an input force measurement and a response measurement. The data acquisition assemblies are also capable of transmitting the data across the WAN. In turn, the central processing elements can receive the data and thereafter perform a modal analysis of the structure based upon the data.

### FIELD OF THE INVENTION

The present invention relates to systems and methods for analyzing a structure and, more particularly, relates to systems and methods for performing a modal analysis of at least one, remotely located structure.

### BACKGROUND OF THE INVENTION

With advanced high-speed machining (HSM) processes, manufacturing companies, such as aircraft manufacturers, are able to manufacture structural components with reduced cycle times and increased productivity. Similarly, HSM of aluminum parts offers higher metal removal rates and, therefore, potential for more profitable operations. Such HSM of aluminum parts has been proven in the aerospace industry over the last decade, when manufacturers began machining components with spindle speeds in the range of 10-15,000 rpm. During this time, however, it has also been found that HSM poses a new set of problems that can be very costly for manufacturers. These new problems can lead to rapid spindle failures and to scrapped parts due to a number of different causes, one of which is chatter.

Generally, chatter can be described as a self-generated or self excited vibration in a closed loop system. In HSM processes, then, the cutting of components is considered a closed loop system with a delayed feedback. To more effectively describe chatter in the context of cutting components, then, consider an end mill with two teeth, A and B, running at 6000 rev/min or 100 rev/sec. The time for one revolution, then, is 1/100 or 10 msec, and the time between when tooth A and tooth B pass over the same spot on the surface is 5 msec. Next, assume a minute vibration in the machine caused tooth A to make a small waviness in the surface it cut. The waviness is sensed by the following tooth B, which then has to cut this waviness in addition to what is normally cut. Tooth B will therefore exert force on the cutter spindle structure thereby causing vibration that could either magnify the waviness or make it smaller after tooth B has passed over the respective point.

If tooth B causes magnification, during the next pass over the respective point, tooth A may further magnify the cut previously made by tooth B, which can result in the system breaking out in chatter vibration. Because the frequency of the chatter is often close to the resonance frequency of the structure, the deflection of the cutter-holder-spindle shaft structure is often so large that bearing forces will exceed the allowable limits, and therefore overheat and/or “lock up”. It will be noted that the frequency of chatter is not the same as the tooth passing frequency, in this case 200 Hz. Instead the chatter frequency is typically close to the resonance frequency of the structure, often 250 to 1000 Hz.

In an attempt to deal with new problems created by HSM, some manufacturers have developed systems to improve HSM processes. For example, manufacturers such as The Boeing Company have implemented software systems used by numerical control (NC) programmers of milling machine operations to select optimal cutting parameters, such as axial and radial depth of cut, feed rate and spindle speed. For example, the software package utilized by The Boeing Company, referred to as Machining Prediction Software (MPS), has been used to design new cutters with inserts. As another example, MPS has been used to predict chatter for machining weak part structures, such as spar chords when setup so they are clamped on one leg with a dovetail on the extrusion angle. Another example of using MPS for predicting chatter is in the machining of so-called T-chords, used for attaching the lower wing surface to the side of the body. Software systems, such as MPS, allow these manufacturers to operate respective machines to aggressively cut components without overloading machine parts in the spindle, such as bearings, the holder, and the spindle taper interface. For more information on MPS, see Jan Jeppsson, Sensor Based Adaptive Control and Prediction Software—Keys to Reliable HSM, presented at Society of Manufacturing Engineers (SME)— APEX '99 Machining & Metalworking Conference (Sep. 15, 1999).

As will be appreciated, software packages such as MPS utilize physical models of HSM processes. It will also be appreciated that, as the software systems utilize physical models, the software systems require a set of input variables that are needed for calculation of output data. For example, MPS requires input variables such as those related to the cutter holder structure, part structure, cutter dimensions and static deflection of thin part flanges. In this regard, data for the cutter holder structure is measured with modal analysis techniques. As is known to those skilled in the art, modal analysis is a technique for experimentally measuring the dynamic characteristics of a structure, such as the cutter holder structure.

According to one type of modal analysis technique, sometimes referred to as impact or tap test, a small hammer with a force sensor is used to tap the cutter such that the cutter's response to the tap can be measured. Once the data has been measured, a spectrum analyzer can be used to analyze the data for use in predicting chatter in the cutter holder structure. In this regard, whereas the tap test can be performed by an operator with little knowledge about modal analysis, most available spectrum analyzers are difficult to use for shop technicians, unless they have a threshold level of engineering knowledge.

As most spectrum analyzers are difficult to use for shop technicians, special training is typically required to provide operators of such analyzers with the threshold level of knowledge. It will be appreciated, however, that many manufacturing companies include manufacturing facilities in many areas located over a large geographic area. In this regard, to apply software systems such as MPS and, more particularly, the spectrum analysis of such software systems, conventionally requires training operators at each facility, or training one or more operators and requiring those operators to travel from facility to facility. Both scenarios, however, are prohibitively expensive and can result in undesirable delays in utilization of the tested machines.

### SUMMARY OF THE INVENTION

In light of the foregoing background, embodiments of the present invention provide an improved system and method for performing modal analysis on at least one structure. The system and method of embodiments of the present invention allow an operator at one location to acquire measurements from the structure, such as by performing a tap test. The measurements can then be transmitted across a network, such as a wide area network (WAN) like the Internet, where the modal analysis can be performed based upon the measurements. More particularly, a shop technician proximate the structure can acquire the measurements from the structure, typically while being led through the measurement acquiring process by a skilled technician at a location remote from the shop technician and the structure. Then, either as the measurements are acquired or anytime thereafter, the measurements can be transmitted across the WAN to the skilled technician such that the skilled technician can perform the modal analysis.

Measurements for multiple structures can therefore be acquired at multiple locations by shop technicians who do not have expertise with respect to modal analysis. The measurements can then be transmitted to one or more locations where an operator skilled in modal analysis can perform the modal analysis for the structures based upon the measurements. As such, the systems and methods of embodiments of 10 the present invention can perform modal analysis on structures spaced great distances from one another without training operators at each facility, or training one or more operators and requiring those operators to travel from facility to facility, as required by conventional techniques.

According to one aspect of the present invention, a system is provided for performing a modal analysis of at least one structure across a wide area network (WAN), such as the Internet. The system includes at least one data acquisition assembly and at least one central processing element. The data acquisition assembly is capable of acquiring data from the at least one structure, where the data comprises an input force measurement and a response measurement. The data acquisition assembly is also capable of transmitting the data across the WAN.

More particularly, each data acquisition assembly can impart a force on the structure and thereafter measure the input force to the structure and the response of the structure to the input force. In this regard, each data acquisition assembly can include a force excitation element, a force sensor, an accelerometer and a client processing element. The force excitation element can impart the force, and the force sensor can measure the input force on the structure. Upon imparting force on the structure, the accelerometer can measure the response of the structure to the input force. In turn, the client processing element can receive the input force measurement and the response measurement and thereafter transmit the data across the WAN to the at least one central processing element.

The central processing element, in turn, is capable of receiving the data. Upon receipt of the data, the central processing element can perform a modal analysis of the structures based upon the force input measurement and the accelerator response measurement. For example, the central processing element can receive the data and thereafter determine a frequency response function (FRF) for the structure based upon the data. In various embodiments, the system also includes at least one display, which can be driven by the central processing element. In such embodiments, the central processing element can drive the display to present the FRF, the force input measurement and/or the accelerator response measurement.

A method of performing a modal analysis on at least one structure is also provided.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system for performing modal analysis of at least one structure according to one embodiment of the present invention;

FIG. 2 is a schematic block diagram of a data acquisition assembly and an exemplar structure according to one embodiment of the present invention;

FIG. 3 is a schematic block diagram of a central processing element according to one embodiment of the present invention; and

FIG. 4 illustrate two exemplar graphs presented by a display of one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

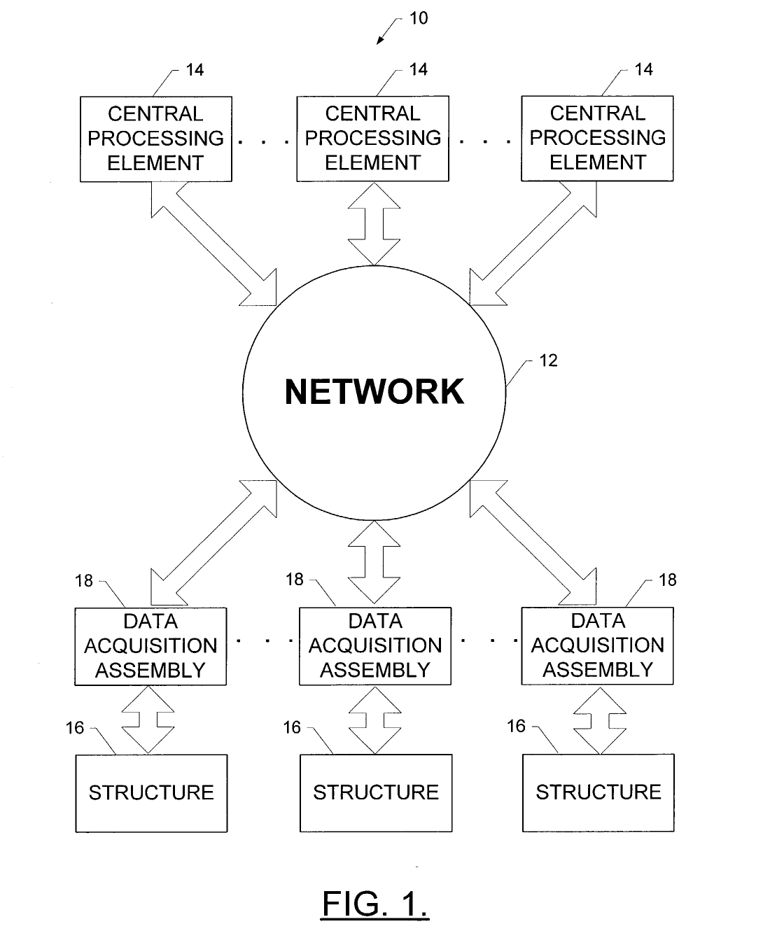

Referring to FIG. 1, a system 10 for remote modal analysis of at least one structure across a network 12 is shown. The network 12 can comprise any of a number of different networks, such as a wide area network (WAN). And whereas WAN can comprise any of a number of different wide area networks, the WAN preferably comprises the Internet. Advantageously, performing the modal analysis across the network, an operator experienced in spectrum analysis can oversee the modal analysis of a plurality of different structures, such as machine tools, located in different locations. In this regard, the system 10 of the present invention includes at least one central processing element 14 that can perform the modal analysis on data from one or more respective structures. For example, each central processing element 14 can be connected to receive data from one or more structures. Alternatively, each of a plurality of central processing elements 14 can be connected to receive data regarding one or more structures. Typically, each structure is associated with one central processing element. Regardless of the network configuration, each central processing element can comprise any number of elements, but typically comprises a personal computer, laptop computer or other high level processor.

The system 10 also includes at least one structure 16, such as a machine tool located in a factory or shop from which the machine tool is used in a manufacturing process. The central processing elements 14 and shops can be located proximate one another but, advantageously, the central processing elements 14 and shops can be located remote from one another. In this regard, by using the network 12, the system 10 of the present invention allows an operator at one location (e.g., the central processing element) to oversee and analyze data received from a structure 16 at a second location (e.g., the shop).

To acquire data for each structure 16 to be analyzed, the system 10 includes at least one data acquisition assembly 18. The data acquisition assemblies 18 are capable of acquiring data from the structures 16, which will thereafter be analyzed by the central processing elements 14. In this regard, the data acquisition assemblies 18 are also capable of communicating with the central processing elements 14, such as via the network 12. For example, the central processing elements 14 and data acquisition assemblies 18 can communicate to transmit and receive the data according to a predetermined protocol such as, for example, the point-to-point protocol (PPP). Advantageously, the data can be transmitted and received in real time such that analysis of the structure can also be performed in real time.

In a typical scenario, shop technicians proximate the structure can acquire data from the structure 16 utilizing the data acquisition assemblies 18. As the shop technicians are typically unskilled in acquiring the data, however, the shop technicians can communicate, such as by telephone, with a skilled technician located proximate a central processing element 14. Being led by the skilled technician, then, the shop technician can acquire the data from the structure 16. Either as the data is acquired, or at anytime thereafter, the data can be transmitted via the network 12, such as according to the PPP protocol, to the central processing element 14 proximate the skilled technician. With the data, then, the skilled technician can command the central processing element 14 to perform the modal analysis on the data. As indicated above, the data can advantageously be transmitted to the central processing element in real time. As such, the central processing element can be commanded in real time to perform modal analysis on the data.

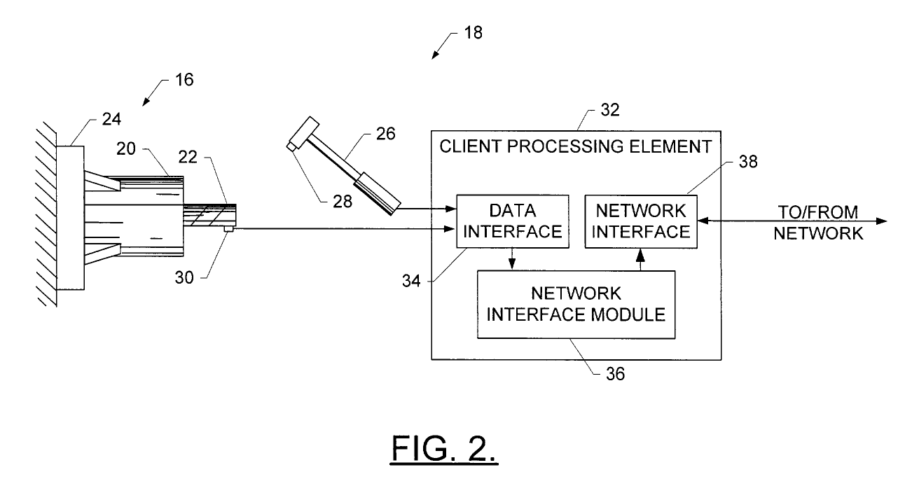

Reference is now drawn to FIG. 2, which illustrates one data acquisition assembly 18 and one type of structure 16 capable of being analyzed according to embodiments of the present invention. The illustrated structure 16 comprises a spindle housing 20 to which a cutting tool, such as an end mill 22, is attached. The spindle housing 20 has a base portion which is connected to a milling machine 24, most of which is not shown. It will be appreciated that the spindle housing 20 is exemplary of many similar structures used in connection with milling machines and is well-known in the art. It will also be appreciated that the illustrated structure is only one example of a type of structure 16 capable of being analyzed according to embodiments of the system 10 and method of the present invention and, as such, should not be interpreted to limit the scope of the present invention.

The data acquisition assembly 18 includes a force excitation element capable of imparting a force on the structure 16. In this regard, the force excitation element can comprise any of a number of elements, including a modal hammer 26, shaker or the like, as such are known to those skilled in the art. To measure the input force applied to the structure 16, which is typically in the form of a short impulse, the data acquisition assembly 18 also includes a force sensor 28. The force sensor 28 can comprise any of a number of known force sensors but, in embodiments where the force excitation element comprises a modal hammer 26, the force sensor 28 is preferably in combination with the modal hammer 26. For example, the modal hammer 26 and force sensor 28 can comprise a Model No. 086C02 or Model No. 086C04 impulse hammer with force sensor manufactured by PCB Piezoelectronics, Inc. of Depew, N.Y.

To measure the response of the structure 16 upon being imparted with an input force from the modal hammer 26, the data acquisition assembly 18 includes an accelerometer 30. The accelerometer 30 is disposed proximate the structure 16, and is preferably secured to the structure 16 at a predefined location. In this regard, the accelerometer 30 is capable of measuring the response of the structure 16, typically in the form of vibrations in the structure 16 caused by the input force from the modal hammer 26. The accelerometer 30 can comprise any of a number of known devices but, according to one embodiment, the accelerometer comprises a Model 352A10 accelerometer manufactured by PCB Piezoelectronics, Inc.

It will be appreciated that in many instances the structure 16 will have a different response depending on the predefined location of the accelerometer 30. Thus, in a typical operation, a number of predefined locations on the structure 16 will be identified prior to operation of the modal hammer 26, force sensor 28 or accelerometer 30. For example, three to five locations can be predefined on a typical end mill 22 of a milling machine 24. The accelerometer 30 can then be secured to the structure 16 at each of the predefined locations. In this regard, a single accelerometer 30 can be secured sequentially at the different locations or multiple accelerometers 30 can be concurrently secured to the plurality of locations. And as the accelerometer 30 is secured at each location, the modal hammer 26 can impart the input force on the structure 16, and the force sensor 28 and accelerometer 30 can measure the respective measurements.

The data acquisition assembly 18 also includes a client processing element 32 that is electrically connected to the force sensor 28 and the accelerometer 30. The client processing element 32 can comprise any of a number of different devices, such as a personal computer, laptop computer or other high level processor. The client processing element 32 is capable of receiving data comprising the input force and response measurements from the force sensor 28 and accelerometer 30, respectively. Upon receipt of the data, then, the client processing element 32 is capable of processing the data and thereafter transmitting the data to a central processing element 14 via the network 12.

The client processing element 32 includes a data interface 34, a network interface module 36 and a network interface 38. The data interface 34 is capable of receiving data including the input force and response measurements of the force sensor 28 and accelerometer 30, respectively, and can comprise any of a number of known interfaces. For example, the data interface 34 can comprise a Personal Computer Memory Card International Association (PCMCIA) card configured to receive the data from the force sensor and the accelerometer. Upon receipt of the data, the data interface 34 is capable of passing the data to the network interface module 36.

The network interface module 36, in turn, is capable of packaging the data in a format for subsequent transmission to a central processing element 14. In addition to the measurements, the packaged data can also include an identifier associated with the structure 16 from which the data was measured and/or the data acquisition assembly 18 that acquired the data. While the network interface module 36 can comprise any of a number of different hardware or firmware devices capable of packaging the measurements, the network interface module 36 is preferably a computer software program operating within the client processing element 32.

Once the data has been packaged, the packaged data can pass to the network interface 38. And upon receipt of the packaged data, the network interface 38 can transmit the packaged data to the central processing element 14 via the network 12. The network interface 38 can comprise any of a number of different known devices but, in one embodiment, the network interface 38 comprises an Ethernet PCMCIA card, as such are known to those skilled in the art. The packaged data can be transmitted to one or more central processing elements 14 in any one of a number of different manners. For example, the formatted measurements can be transmitted according to the point-to-point protocol (PPP).

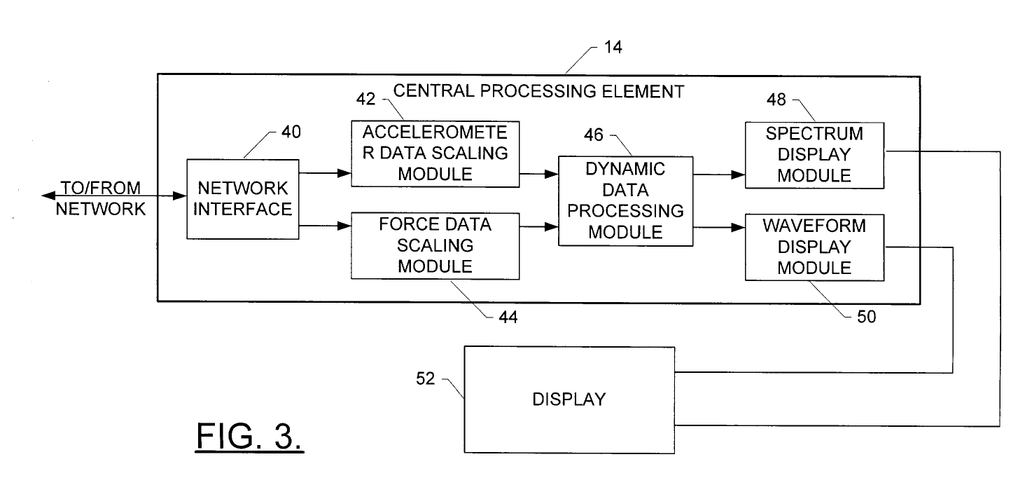

Reference is now drawn to FIG. 3, which illustrates a schematic block diagram of one central processing element 14 according to embodiments of the present invention. The central processing element 14 is capable of receiving the packaged data from the client processing element 32 and thereafter performing data processing, such as FFT (Fast Fourier Transform), on the data. In this regard, the central processing element 14 includes a network interface 40, accelerometer and force data scaling modules 42 and 44, respectively, and a dynamic data file module 46. Additionally, the central processing element 14 can include spectrum and waveform display modules 48 and 50, respectively.

Upon transfer of the packaged data from the network interface 38 of the client processing element 32, the network interface 40 of the central processing element 14 is capable of receiving the packaged data and thereafter unpacking the data into a the measurements and identifier in a format capable of being processed by the central processing element 14. In this regard, from the identifier the central processing element 14 can identify the originating location of the data, such as from the identifier associated with the structure 16 from which the data was measured and/or the data acquisition assembly 18 that acquired the data. Like the network interface 38 of the client processing element 32, the network interface 40 of the central processing element 14 can comprise any of a number of different devices, including an Ethernet PCMCIA card.

Once the network interface 40 of the central processing element 14 has unpacked the data, the data can be transferred to respective processing modules. In this regard, the response data can be transferred to an accelerometer data scaling module 42, and the force data can be transferred to a force data scaling module 44. The scaling modules 42, 44 can process the respective data by performing at least one operation on the data to prepare the data for modal analysis. For example, the scaling modules 42, 44 can perform scaling, averaging and/or any of a number of other functions on the data, as such are known to those skilled in the art. Like the network interface module 36 of the client processing element 32, the scaling modules 42, 44 can comprise any of a number of different hardware or firmware devices capable of processing the data. In one advantageous embodiment, for example, the scaling modules 42, 44 comprise computer software programs operating within the central processing element 14. It should be understood that, although, the central processing element 14 is illustrated and described as including a separate scaling module for processing the accelerometer and force data, the central processing element 14 can include a single processing element capable of performing the functions of both the accelerometer data scaling module 42 and the force data scaling module 44.

After the accelerometer and force data scaling modules 42 and 44 have processed the accelerometer and force data, respectively, the processed data is passed to the dynamic data file module 46. The dynamic data processing module 46 receives the processed measurements and thereafter further processes the data into a format for subsequent processing and display. For example, the dynamic data processing module 46 can perform modal analysis based upon the data by converting the data from a series of time points into a spectrum format and thereafter determining the frequency response function (FRF) for the structure 16 based upon the data as is known to those skilled in the art. The dynamic data processing module 46 can comprise any of a number of different hardware or firmware devices capable of processing the measurements but, in one advantageous embodiment, the dynamic data processing module 46 comprises a computer software program operating within the central processing element 14.

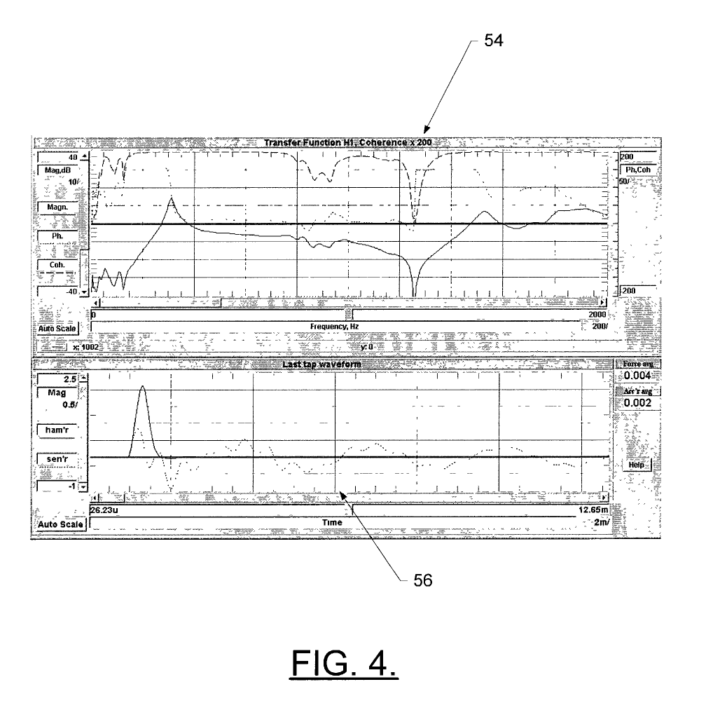

Once the dynamic data processing module 46 has further processed the data, the data and/or FRF can be displayed and subsequently analyzed in any of a number of different manners. In one embodiment, for example, the FRF and data are transferred to spectrum and waveform display modules 48 and 50, respectively. The display modules 48, 50 are capable of driving a display 52, such as a monitor or the like, to present the FRF and/or the data. In this regard, the spectrum display module 48 can drive the display 52 to present the frequency response function (FRF) such that an operator can determine the relationship between the input force to the structure 16, and the response of the structure 16 (i.e., vibration magnitude). For example, the spectrum display module 48 can drive the display 52 to present the vibration magnitude per unit force applied versus frequency, as shown by the top graph of FIG. 4 (designated 54). The waveform display module 50, on the other hand, can drive the display 52 to present the waveforms of the input force and response data as a series of time points, such as is shown by the bottom graph of FIG. 4 (designated 56).

With the presentations of the display 52 and/or the FRF, the modes of the structure 16 can be defined, as such are known. It will be appreciated that the input force and response measurements can be used in any of a number of other applications, such as in predicting chatter in structures such as the end mill 22 of the milling machine 24. In such an application, further processed data from the dynamic data processing module 46 can be converted into a mathematically fitted function by the central processing element 14, such as by a curve fitting module (not shown). The curve fitting module can comprise any of a number of hardware, firmware or software devices capable of converting the data in accordance with the present invention. In one embodiment, for example, the curve fitting module comprises the ME'SCOPE software package distributed by Vibrant Technology, Inc. of Jamestown, Calif.

The mathematically fitted function is defined by a number of modal parameters based upon the data. For example, the modal parameters can include, among others, for each mode of the structure 16 and each predefined location of the accelerometer 30 on the structure 16, a frequency, a damping and a mode shape normalized magnitude. In this regard, the frequency comprises one of the natural frequencies of the structure 16. The damping is a measure of how long the vibration response of the structure 16 lasts after the input force is applied to the structure 16. And the mode shape normalized magnitude comprises the relative magnitude of vibration (i.e., response) for each location of the accelerometer 30 on the structure 16. Once the modal parameters have been defined by the mathematically fitted function, chatter in the structure 16 can be predicted by the central processing element 14, such as within a prediction module (not shown) as is known in the art. In this regard, the prediction module can comprise any of a number of different hardware, firmware or software devices capable of predicting chatter based upon the modal parameters. For example, the prediction module can comprise the Machining Prediction Software (MPS) software package developed by The Boeing Company.

Therefore, embodiments of the present invention provide an improved system 10 and method for performing modal analysis on at least one structure 16. The system 10 and method of embodiments of the present invention allow an operator at one location to acquire measurements from the structure 16, such as by performing a tap test. The measurements can then be transmitted across a network 12, such as a wide area network (WAN) like the Internet, where the modal analysis can be performed based upon the measurements. As such, the systems 10 and methods of embodiments of the present invention can perform modal analysis on structures 16 spaced great distances from one another without training operators at each facility, or training one or more operators and requiring those operators to travel from facility to facility, as required by conventional techniques.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for performing a modal analysis of at least one structure across a wide area network (WAN), said system comprising:
at least one data acquisition assembly capable of acquiring data from the at least one structure, wherein the data comprises an input force measurement and a response measurement, and wherein the at least one data acquisition assembly is capable of transmitting the data across the WAN; and
at least one central processing element, remote from the at least one data acquisition assembly, capable of receiving the data from the WAN and thereafter performing a modal analysis of the at least one structure based upon the data.

2. A system according to claim 1, wherein the WAN comprises the Internet.

3. A system according to claim 1, wherein each data acquisition assembly is capable of imparting a force on the at least one structure and thereafter measuring the input force on the at least one structure and a response of the at least one structure to the input force.

4. A system according to claim 3, wherein each data acquisition assembly comprises:
a force excitation element capable of imparting the force on the at least one structure;
a force sensor capable of measuring the input force on the at least one structure;
an accelerometer capable of measuring the response of the at least one structure to the input force; and
a client processing element capable of receiving the input force measurement and the response measurement and thereafter transmitting the data across the WAN to the at least one central processing element.

5. A system according to claim 1, wherein the at least one central processing element is capable of receiving the data and thereafter determining a frequency response function (FRF) for the structure based upon the data.

6. A system according to claim 5 further comprising at least one display, wherein the at least one central processing element is capable of driving the at least one display to present at least one of the FRF, the force input measurement and the accelerator response measurement.

7. A method of performing a modal analysis of at least one structure remotely located, said method comprising:
acquiring data from the at least one structure, wherein the data comprises an input force measurement and a response measurement;
transmitting the data across the WAN;
receiving the data from the WAN at a location remote from the at least one structure; and
performing a modal analysis of the at least one structure based upon the data.

8. A method according to claim 7, wherein transmitting the data comprises transmitting the data across the Internet.

9. A method according to claim 7, wherein acquiring data comprises:
imparting a force on the at least one structure; and
measuring the input force on the at least one structure and a response of the at least one structure to the input force.

10. A method according to claim 7, wherein performing a modal analysis includes determining a frequency response function (FRF) for the structure based upon the data.

11. A system according to claim 10 further comprising driving a display to present at least one of the FRF, the force input measurement and the accelerator response measurement.

12. A system for performing a modal analysis of at least one structure across a wide area network (WAN), said system comprising at least one data acquisition assembly, wherein each data acquisition assembly comprises:
a force excitation element capable of imparting the force on the at least one structure;
a force sensor capable of measuring the input force on the at least one structure;
an accelerometer capable of measuring a response of the at least one structure to the input force; and
a client processing element capable of receiving the input force measurement and the response measurement, wherein said client processing element is capable of packaging the measurements along with an identifier identifying an originating location of the data and thereafter transmitting the packaged data across the WAN to at least one central processing element located remote from the data acquisition assembly to permit the at least one central processing element to perform the modal analysis based upon the data.

13. A system according to claim 12, wherein the WAN comprises the Internet.

14. A system according to claim 12 further comprising the at least one central processing element, wherein the at least one central processing element is capable of receiving the data and thereafter determining a frequency response function (FRF) for the structure based upon the data.

15. A system according to claim 14 further comprising at least one display, wherein the at least one central processing element is capable of driving the display to present at least one of the FRF, the input force measurement and the accelerator response measurement.

16. A system for performing a modal analysis of at least one structure across a wide area network (WAN), said system comprising:
at least one central processing element capable of receiving packaged data transmitted across the WAN, wherein the packaged data comprises data including an input force measurement and a response measurement from the at least one remotely located structure, and an identifier identifying an originating location of the data, wherein the at least one central processing element is also capable of performing the modal analysis of the at least one structure based upon the data.

17. A system according to claim 16, wherein the WAN comprises the Internet.

18. A system according to claim 16 further comprising at least one data acquisition assembly, wherein each data acquisition assembly is capable of imparting a force on the at least one structure and thereafter measuring the input force on the at least one structure and a response of the at least one structure to the input force, and wherein each data acquisition assembly is capable of transmitting the data across the WAN to the at least one central processing element.

19. A system according to claim 18, wherein each data acquisition assembly comprises:
a force excitation element capable of imparting the force on the at least one structure;
a force sensor capable of measuring the input force on the at least one structure;
an accelerometer capable of measuring the response of the at least one structure to the input force; and
a client processing element capable of receiving the input force measurement and the response measurement and thereafter transmitting the data across the WAN to the at least one central processing element.

20. A system according to claim 16, wherein the at least one central processing element is capable of receiving the data and thereafter determining a frequency response function (FRF) for the structure based upon the data.

21. A system according to claim 20 further comprising at least one display, wherein the at least one central processing element is capable of driving the at least one display to present at least one of the FRF, the force input measurement and the accelerator response measurement.
